(19) United States
(12) Patent Application Publication
(10) Pub. No.: US 2026/0084359 A1
(43) Pub. Date: Mar. 26, 2026

(54) Method for Supporting the Implementation of a Process Change, Computer Program Product and System

(71) Applicant: Windmöller & Hölscher KG, Lengerich (DE)

(72) Inventors: Daniel Niehues, Lengerich (DE); Tobias Kulgemeyer, Lengerich (DE); Till Bergmann, Lengerich (DE)

(21) Appl. No.: 19/109,934

(22) PCT Filed: Sep. 8, 2023
(86) PCT No.: PCT/EP2023/074797

§ 371 Date: Mar. 7, 2025

(30) Foreign Application Priority Data
Sep. 9, 2022 (DE) 10 2022 123 025.2

(51) Int. Cl. B29C 48/25; B29C 48/08; B29C 48/285; B29C 48/92

(52) U.S. Cl. CPC B29C 48/2692; B29C 48/286; B29C 48/92; B29C 48/08; B29C 2948/92485; B29C 2948/92704; B29C 2948/9298; B29C 2948/9299

(57) ABSTRACT

The invention relates to a method (100) for supporting the implementation of a process change from a manufacturing process (200) for manufacturing a first film material (201) to a subsequent process (210) for manufacturing a second film material (211) in an extrusion device (10). Furthermore, the invention relates to a computer program product and a system (1).

The invention relates to a method for supporting the implementation of a process change from a manufacturing process for manufacturing a first film material to a subsequent process for manufacturing a second film material in an extrusion device, a computer program product, and a system.

It is generally known that different products can be manufactured using extrusion devices in the form of film machines. The products usually differ from one another due to their different recipes. This means that a series of different orders with different recipes are processed sequentially one after the other. For the transition between two recipes, a change is made from a recipe currently in use to a subsequent recipe. In known solutions, this change is usually carried out manually and based on the experience of the machine operator.

The disadvantage of such solutions is that the quality and, above all, the time required to implement the change from one recipe to the subsequent recipe is based solely on the knowledge of the machine operator. This means that a very high rejection rate can be achieved for this change between recipes, particularly with inexperienced machine operators. In particular, it is not possible to achieve a clear and continuous quality requirement for all changes to subsequent recipes in this way. Last but not least, the possibility of errors cannot be ruled out.

It is therefore known from DE 10 2015 108 974 A1 to predetermine a process limiting in the form of an end of a production order and to specify a reduced changeover filling level in anticipation of this end of the production order. This makes it possible to reduce material waste due to excess material during the process change. However, the view of the material is at least essentially from the perspective of the input material. It would be desirable to optimize other aspects of a process change.

It is an object of the present invention to at least partially eliminate the above disadvantages known from the prior art. In particular, it is an object of the present invention to improve the planning and/or implementation of a process change in an extrusion device through increased prediction accuracy.

The above problem is solved by a method having the features of claim 1, a computer program product having the features of claim 19, and a system having the features of claim 20. Further features and details of the invention are apparent from the respective dependent claims, the description and the drawings. Features and details which are described in connection with the method according to the invention naturally also apply in connection with the computer program product according to the invention and/or the system according to the invention and vice versa, so that reference is or can always be made to the individual aspects of the invention with respect to the disclosure.

According to a first aspect of the invention, there is provided a method for supporting an implementation of a process change from a manufacturing process for manufacturing a first film material to a subsequent process for manufacturing a second film material in an extrusion device. The method comprises, in particular in the form of method stages/steps:
capturing of process data of the manufacturing process, in particular by a control system,
capturing of subsequent process data of the subsequent process, in particular by the control system,
predetermining at least one material flow within the extrusion device for the process change depending on the process data and/or the subsequent process data, in particular by the control system,
executing of at least one preparatory measure for causing at least one process change event depending on the material flow, in particular by the control system.

The extrusion device can advantageously be a film machine, in particular a cast film machine and/or a blown film machine. The extrusion device may comprise one or more extruders for heating, mixing and/or conveying raw material.

Preferably, the first and second film materials are each in the form of a plastic film. The first film material and the second film material can preferably differ in a recipe, i.e. in particular in a material composition, and/or in a format. For example, different raw materials and/or different proportions of raw materials can be used for the first and second film materials. The format can preferably be understood as a geometric configuration, such as a film width and/or film thickness, of the first and second film material. A production result of the manufacturing process can comprise a first film product, e.g. a tubular and/or flat film, and a production result of the subsequent process can comprise a second film product, e.g. a tubular and/or flat film. The first and second film products can each be produced and/or processed in individual film sections or as a continuous product.

The manufacturing process and the subsequent process can each comprise a manufacturing job. The process change can preferably take place without stopping the extrusion device, so that the manufacturing process and the subsequent process merge into one another and/or film material is permanently produced. The manufacturing process is understood in particular to mean a good production of the first film material, i.e. a production of the first film material which satisfies at least one quality criterion for the first film material, in particular for the sale of the first film material. The subsequent process is understood in particular to be a good production of the second film material, i.e. a production of the second film material which satisfies at least one quality criterion for the second film material, in particular for the sale of the second film material. Between the manufacturing process and the subsequent process, a changeover process can be carried out in which only material waste is produced which satisfies neither the quality criterion for the first film material nor the quality criterion for the second film material. The changeover process is preferably minimized by the method according to the invention.

The process data can comprise a process parameter set with one or more process parameters of actual machine data and/or setpoint machine data of the extrusion device, in particular in the form of sensor data and/or control and/or regulation data, for the manufacturing process. For example, the Process parameter set may comprise temperature data of the extrusion device and/or material conveying data of the extrusion device, in particular in the form of a conveying speed, a pressure in an extruder and/or an extruder speed. It may be provided that the process parameter set is used to continuously or discontinuously control and/or regulate the extrusion device when the extrusion device is controlled during the manufacturing process. For this purpose, the process parameter set can be transmitted from the control system to the extrusion device, in particular to components of the extrusion device.

The subsequent process data can comprise a set of setpoint subsequent parameters with one or more subsequent process parameters of setpoint machine data of the extrusion device, in particular in the form of control and/or regulation data for the subsequent process. In particular, the setpoint subsequent parameter set may comprise temperature data of the extrusion device and/or material conveying data of the extrusion device, in particular in the form of a conveying speed, a pressure in an extruder and/or an extruder rotational speed. Thus, the setpoint subsequent parameter set may comprise one or more subsequent process parameters that are associated with the one or more process parameters of the process parameter set, but relate to the subsequent process. Furthermore, the subsequent process data may comprise material data, such as material properties of the second film material and/or a material ingredient for the second film material, for the subsequent process. When capturing the subsequent process data, the subsequent process data can, for example, be retrieved from a memory device and/or from a database. However, it is also conceivable that the subsequent process data is captured by user input, in particular at the extrusion device. The process data and the subsequent process data can also be used to detect whether the process change involves a format and/or material change.

When predetermining the material flow in advance, the material flow can advantageously be calculated and/or determined empirically, in particular analytically and/or numerically. For example, it is conceivable that an observed material flow is extrapolated over a certain period of time. The material flow can represent a movement of at least one or more material ingredients for the first and/or second film material. To predetermine the material flow, the process data and the subsequent process data can be used to provide information about boundary conditions and/or material ingredients. For example, the process data and the subsequent process data can be used to determine whether certain actions, such as a rinsing operation, are required for the process change in order to set up the subsequent process based on the subsequent process data. These actions can determine the material flow, e.g. of a rinsing material. Furthermore, it is conceivable that the process data comprises material data of at least one first material ingredient used in the manufacturing process and the subsequent process data comprises subsequent material data of at least one second material ingredient used in the subsequent process instead of the first material ingredient. The material flow can represent a movement of a yield point between the first and second material ingredient. In particular, the event is a process event. For example, the event may comprise a certain value of a process parameter being reached and/or a material ingredient arriving at an event location. In particular, it is conceivable that the event comprises a modification of the first material ingredient, in particular to the second material ingredient, in a device section of the extrusion device.

The preparatory measure is preferably carried out automatically depending on the material flow. In particular, the preparatory measure is implemented during the manufacturing process, i.e. before the process change and/or the process completion of the manufacturing process. The preparatory measure can be configured to automatically execute and/or support an at least partial adjustment of the current process data to the subsequent process data.

In particular, the material flow determines a significant part of the process change, as the material ingredients involved move within the extrusion device from a material supply to an outlet for the particular film material being produced. It has therefore been recognized within the scope of the invention that this can be used to coordinate the preparatory measure with the material flow in order to enable an efficient process change. For example, a material changeover of a material ingredient of a feed device can be initiated before the manufacturing process is completed. Because the preparatory measure is carried out depending on the determined material flow, the event can be triggered, for example, when a subsequent material replaces an input material at a certain point in the extrusion device. This can shorten the time required for the process change. For example, it is conceivable that the preparatory measure is already carried out during the manufacturing process in order to be able to continue production for as long as possible without being affected by the manufacturing process during the process change, especially if there is already subsequent material in the extrusion device. Due to the complexity of film manufacturing, actions can also have an effect on several process parameters. Based on the material flow, the method according to the invention makes it possible, in particular, to view the process change as a holistic operation in which sub-operations can take place in parallel and/or in coordination with one another in order to be able to utilize and/or coordinate the mutual influence of the material flow and the at least one event.

Furthermore, in a method according to the invention, it may advantageously be provided that the preparatory measure comprises an automatic control of the extrusion device and/or an output of a recommended action for execution by an operator. For automatically controlling the extrusion device, a signal for controlling and/or regulating the extrusion device for the manufacturing process can be sent from the control system to the extrusion device and/or a component of the extrusion device. The control signal can comprise an adjustment of the process parameter set, in particular in the form of setpoint process parameters and/or setpoint process parameter curves. The automatic control can free up time for an operator, which the operator can use to execute further preparatory measures, such as material provision. The recommended action can, for example, include an instruction to execute a manual activity. The recommended action can be output, for example, by displaying the recommended action on a display device, in particular in the form of a visualization. Preferably, the recommended action can be visualized depending on the type of process change. The type of process change can be used to differentiate whether the process change involves a material and/or format change. The recommended action can be used to provide user guidance during the process change in order to instruct an operator of the extrusion device.

Within the scope of the invention, it is also conceivable that the material flow is predetermined using a calculation model for a material distribution and/or a material movement in the extrusion device. The calculation model can be predefined and/or stored, for example, in a memory device of the control system. The calculation model can be configured for analytical and/or numerical calculation of the material flow. It is conceivable that the calculation model comprises geometry data of the extrusion device. Preferably, a movement path of the material flow is mapped by the calculation model so that the material flow can be calculated along the movement path depending on control data of the extrusion device. Material data, such as a viscosity and/or a melt flow index, can be taken into account by the calculation model to predetermine the material flow. The calculation model can be used to achieve a high level of accuracy when predetermining the material flow. In particular, predictions for the material flow can be determined in order to cause the event depending on the material flow and/or to coordinate the material flow and the event.

Furthermore, in a method according to the invention, it is conceivable that the event can be caused or is caused by the execution of the preparatory measure at an event location of the extrusion device, and the execution of the preparatory measure is coordinated in time with the material flow, so that the material flow correlates in time with the event at the event location. In particular, the event location comprises a device section of the extrusion device. For example, the event location may comprise a material outlet and/or a material inlet of an extruder, a melt gap and/or a section of a film bubble. It may be provided that, when predetermining the material flow, a conveying time of a material ingredient for the second film material and/or the rinsing operation up to the event location for the first film material is calculated and the material change and/or the rinsing operation takes place depending on the conveying time. For example, the material flow can be used to determine when the material ingredient reaches the film bubble from a feed device. By coordinating the preparatory measure with the material flow, the film bubble can be stabilized in good time by the preparatory measure and/or it can be predetermined how long the first film material will still be produced without the material ingredient. As a result of the improved coordination between the event and the material flow, a high level of accuracy can be achieved when controlling the process changeover in order to minimize a changeover time and/or improve process stability.

Furthermore, in a method according to the invention, it may advantageously be provided that the material flow comprises a movement of a material in the extrusion device to the event location, wherein the event comprises reaching a setpoint value of a process parameter, in particular at the event location. The setpoint value may comprise, for example, a degree of homogeneity in the film bubble, a specified temperature value, an extruder speed value and/or an extruder pressure. For example, it may be necessary for a predefined temperature to be reached at a device section of the extrusion device when the one material ingredient of the second film material reaches the device section. Depending on a component of the extrusion device associated with the device section, a temperature modification, i.e. in particular heating or cooling, of the device section may require a period of time. The preparatory measure may comprise controlling the device section to modify the temperature to the setpoint value. The preparatory measure can be timed to the material flow in such a way that the temperature modification is completed, i.e. the setpoint value is reached when the material reaches the device section. This can ensure that there is sufficient viscosity of the material in the preparation section to be able to further convey and/or mix the material. At the same time, a material previously in the device section can be exposed to no or only a slowly increasing influence of the temperature modification for as long as possible. As a result, the process change can be configured to be particularly sharp-edged, in that the first film material is produced as a good production for as long as possible, taking into account a quality criterion.

Furthermore, in a method according to the invention, it may advantageously be provided that the preparatory measure comprises at least one, several or all of the following change operations at least partially or completely:
modifying a material supply, in particular for changing a material ingredient,
adjusting of a temperature of the extrusion device, in particular of a device section of the extrusion device,
modifying the process data to maintain bubble stability of a film bubble, especially during temperature adjustment and/or by modifying a manufactured film format, generating an intermediate material for a start operation for an intermediate process.

When modifying the material supply, for example, a suction lance for sucking in a material ingredient can be moved between two supply containers in order to modify the material ingredient. Furthermore, a setpoint filling level can be predefined to modify the material supply so that the event occurs in the form of an emptying or approximate emptying of the material supply when a predefined material quantity of the first film material is reached. When adjusting the temperature of the extrusion device, for example, a film blowing head of the extrusion device can be heated up or cooled down in order to be prepared for a material change. When modifying the process data to maintain bubble stability, for example, a film format can be modified by adjusting a film thickness and/or a tube diameter. This can prevent the extruded material in the film bubble from becoming too thin and the film bubble from rupturing. By maintaining the bubble stability, the ongoing process can be maintained and a restart of the extrusion device can be prevented. It is also conceivable that, depending on the material flow, a material change sequence of several extruders of the extrusion device is defined for the material change in order to maintain a production process of the extrusion device. During the start operation for the intermediate process, for example, a rinsing operation can be initiated. It is also conceivable that the intermediate process is configured as a transition process between the manufacturing process and the subsequent process. For example, the intermediate process can involve a gradual addition of material ingredients from the subsequent process and/or a gradual modification from material ingredients from the manufacturing process to material ingredients from the subsequent process. The intermediate process can be started during the start operation, e.g. by making a first material modification. The change operations can therefore be used to carry out the actions required for the process change and coordinate them with the material flow. As a result, the process change can be carried out with a high level of efficiency, in particular by reducing the changeover time.

Preferably, in a method according to the invention, it can be provided that the preparatory measure comprises several change operations for executing the process change, in particular wherein the change operations are prioritized and/or output one after the other when implementing the preparatory measure. By executing several change operations during the preparatory measure, a significant part of the process change or the entire process change can be carried out depending on the material flow. When prioritizing the change operations, a sequence of change operations can be defined. The prioritization can be carried out depending on the material flow, the process data and/or the subsequent process data. The prioritization can take place depending on a target variable, in particular a changeover time and/or a quality criterion of the first and/or second film material. For example, the prioritization can determine for which extruder a rinsing operation is carried out first. The output of the change operations can also be carried out in the form of an automated control of the extrusion device and/or in the form of a display of recommended actions. The process change can be planned in advance through the multiple change operations in order to achieve improved coordination of the individual change operations, in particular with regard to the material flow and/or the event.

It is also conceivable in a method according to the invention that the preparatory measure, in particular the change operations, is determined on the basis of a recording of a reference change, in particular from the process data to the subsequent process data. In particular, the reference change can be a recorded process change, especially one in which the same or similar recipes were present compared to the current process change. For example, the reference change can be carried out manually by an experienced operator, such as a lead operator, for recording. This means that other operators who have less experience of the process change can be guided by the reference change to carry out the process change. The reference data can provide an advantageous starting point for the preparatory measure, allowing individual experience in operating the extrusion device and/or in applying different film recipes to be incorporated into the preparation operations. This allows special know-how to be taken into account in the method.

Preferably, in a method according to the invention, it can be provided that an artificial intelligence is provided, to which the process data and the subsequent process data are supplied as input data in order to receive the material flow and/or the preparatory measure as output data, and/or that the implementation data and/or the process history with the sensor data, the process data and/or the subsequent process data are supplied to the artificial intelligence as training data, in particular in order to supply the artificial intelligence with the input data in further subsequent processes and to receive the output data. Preferably, the control system, in particular a control device of the control system, can have the artificial intelligence, in particular in the form of an artificial neural network. The artificial intelligence can be used to create a self-learning system. Furthermore, large amounts of data can be processed by the artificial intelligence in order to optimize the process change.

Preferably, in a method according to the invention, it may be provided that the preparatory measure comprises a rinsing operation of at least a part of the extrusion device, in particular wherein the material flow comprises a movement of a rinsing material of the rinsing operation. During the rinsing operation, the extrusion device can be at least partially or completely cleaned for a material change, in particular by producing an intermediate product with the rinsing material. During the rinsing operation, material residues of a material ingredient of the first film material can thus be removed from the extrusion device in order to prevent contamination of the second film material. It may be provided that a material type of the rinsing material and/or a rinsing time is determined depending on the material flow. This allows, for example, the rinsing time and/or a selection of the material type of the rinsing material to be optimized.

It is also conceivable in a method according to the invention that a rinsing time for the rinsing operation is calculated depending on the process data and the material flow, with the preparatory measure being carried out depending on the rinsing time. In particular, the rinsing time can include a period of time for executing the rinsing operation. In particular, the completion of the rinsing operation can be calculated in advance depending on the rinsing time. Furthermore, depending on the material flow and/or the rinsing time, several different rinsing materials of the rinsing operation, e.g. for purging several different extruders and/or feeding devices, can be coordinated. The preparatory measure may comprise, for example, introducing a material ingredient for the second film material into the extrusion device and/or stopping a material feed of the rinsing material to the extrusion device, in particular so that a material ingredient reaches the film bubble immediately after a completion of the rinsing operation in order to produce the second film material and/or an intermediate material. This ensures that the rinsing operation is carried out over a sufficient period of time and at the same time optimizes the timing for subsequent material ingredients.

Furthermore, in a method according to the invention, it may advantageously be provided that a process completion of the manufacturing process is precalculated depending the material flow, in particular wherein the event is associated with the process completion. In particular, the process completion of the manufacturing process can be understood as a completion of an ordered and/or executed good production of the first film material. The process completion itself can form the event or correlate with the event. For example, the preparatory measure can initiate a material change, which is realized immediately after the process completion on the film bubble. The material flow can be used to predict a material quantity and/or a material speed for a material output, such as a melt gap, for a specific point in time. Assuming that production is carried out unmodified or essentially unmodified, a second point in time can be calculated based on a first point in time of the manufacturing process, for example, at which sufficient material flow has been generated to complete the manufacturing process. The material flow can therefore be used to predetermine when the process will be completed before the required first film material is actually finished.

Furthermore, in a method according to the invention, it is conceivable that the preparatory measure is determined depending on a predefined target variable for the transfer of the extrusion device, in particular wherein the target variable comprises a material quantity, a changeover time of the process changeover, a quality criterion for the first film material and/or the second film material and/or a process reliability when implementing the process changeover. The material quantity can refer to a material ingredient, i.e. in particular a raw material, for the first and/or second film material. However, it is also conceivable that the target variable comprises a material quantity of a film material produced by the extrusion device, i.e. in particular a starting material. In particular, the changeover time can be understood as a period of time between a good production of the first film material and a good production of the second film material. The quality criterion can be a geometric criterion, such as a film thickness and/or a film width. However, it is also conceivable that the quality criterion comprises at least one material property, such as a relaxation value, a tensile and/or tear strength and/or a film transparency. Furthermore, the quality criterion can be an economic criterion, such as material costs. The process reliability can be understood to mean, for example, safety against film breakage during the process change and/or reproducibility of the process change. To determine the preparatory measure, an optimization operation can be carried out with regard to the target variable depending on the material flow, the process data and the subsequent process data. For this purpose, a variation of at least one change action can be carried out and/or simulated depending on the target variable. In this way, the process change can be optimized with regard to the target variable.

Furthermore, in a method according to the invention, it may advantageously be provided that a balancing of a quantity of the first film material and/or a quantity of a material ingredient introduced into the extrusion device takes place, in particular wherein the preparatory measure and/or the calculation of the process completion takes place depending on the balancing. The balancing can be carried out for the part of the manufacturing process that has already been carried out. In particular, the manufacturing process can be divided into several process phases, for each of which the balancing is performed separately. For example, the process phases can include a start phase for starting the manufacturing process, a good production, a bad production and/or phases of different film qualities. In particular, the quantity of the first film material and/or the introduced material ingredient can be measured for balancing. The amount of the first film material and/or the introduced material ingredient may comprise a weight. The amount of the first film material may further be performed by determining the linear meters of the first film material produced, an area of the first film material produced, and/or a number of wraps produced. The amount of material ingredient introduced may, for example, be measured in and/or upstream of one or more extruders of the extrusion device. However, it is also conceivable that the balancing is carried out on the basis of one or more user inputs.

A prompt can be issued to the user for this purpose. Preferably, to determine the preparatory measure, a process inflection point can be determined on the basis of the balancing and/or on the basis of the process completion, from which a continuation of the manufacturing process is no longer possible while maintaining the quality criterion of the first film material. For example, it may be possible to initiate an extension of the manufacturing process before the process inflection point. The process inflection point can be output, in particular displayed, as information for an operator. It can also be provided that an operator is expected to confirm the process inflection point before the preparatory measure is implemented. This can prevent the process inflection point from being reached without the consent of the operator, in particular by the preparatory measure.

It is also conceivable in a method according to the invention that the balancing is carried out depending on the predetermination of the material flow for a point in time lying in the future during the balancing. The material flow can be used to predetermine what quantity of the first and/or second film material has left the extrusion device at the time in the future and/or what quantity of one or more material ingredients for the first and/or second film material will have been introduced into the extrusion device at the time in the future. As a result, a prediction can be made with a high degree of accuracy about the quantities of material produced and/or consumed in order to configuration and/or optimize the process change. Furthermore, the process completion can be predicted with a high degree of precision by balancing.

Furthermore, in a method according to the invention, it may advantageously be provided that the method comprises:
capturing of sensor data to detect a modification in the manufacturing process that occur depending on the preparatory measure, in particular by the control system,
   in particular where the sensor data is monitored with regard to the target variable and/or the determination of the material flow is updated depending on the sensor data. Preferably, the preparatory measure is interrupted and/or a countermeasure is carried out if it is determined from the sensor data that a process condition relating to the target variable is not fulfilled. The sensor data can, for example, include motor current values of an electric motor, temperature values and/or a temperature curve on a component of the extrusion device and/or the like. This can be used to recognize at any time how far the process change has been applied on the extrusion device. Furthermore, the sensor data can comprise image data from a camera, in particular for recognizing a bubble shape. For example, the process condition can include maintaining a bubble shape in order to prevent film breakage and thus an interruption of the manufacturing process. To detect bubble stability of the film bubble, the sensor data can be used to evaluate vibrations and/or wobbling of the film bubble. The sensor data can therefore be used to monitor the influence of the preparatory measure on the manufacturing process.

Preferably, in a method according to the invention, it can be provided that the material flow and/or the preparatory measure is determined on the basis of a process history of previous manufacturing processes. The process history can comprise a database in which process data and/or change actions of previous process changes are stored. The database can be examined for similarities using the process data of the current manufacturing process and/or the subsequent process data of the subsequent process. Furthermore, the database entries in the database can be evaluated with regard to the target variable. Based on the process history, it is therefore not necessary for an operator to have the know-how to implement the process change themselves. Instead, internal know-how from previous process changes can be used to define the preparatory measure.

Furthermore, in a method according to the invention, it may advantageously be provided that implementation data of the preparatory measure, in particular depending on the sensor data, is stored as part of the process history for provision for further subsequent processes. The implementation data can comprise the material data, the process parameter set, the setpoint subsequent parameter set, the at least one quality criterion and/or further process data. In this way, the preparatory measure and/or the current process change can be incorporated into the database available to the control system, thereby improving the know-how of the operation of the extrusion device especially. In particular, if the sensor data is stored with the implementation data, a system reaction to the preparatory measure can also be recognized. In particular, the evaluation based on the sensor data can be stored with the implementation data. The method can therefore be configured to be self-learning.

Within the scope of the invention, it is further conceivable that the method comprises:
determining the subsequent process using a process collection for the manufacturing of different film materials by analyzing the process collection using the process data and the subsequent process data.

In particular, the subsequent process can be determined depending on the target variable. It is conceivable that several target variables are taken into account when determining the subsequent process. The process collection can include several planned manufacturing processes, for example in the form of an order list of film materials to be manufactured. By determining the subsequent process, the subsequent process can be determined automatically from the planned manufacturing processes in order to match the subsequent process to the current manufacturing process. This can simplify the process change. When analyzing the process collection, the process data of the current manufacturing process can be compared with the process data of the planned manufacturing processes. For example, the recipes of the planned manufacturing processes can be checked for similarity to the recipe of the current manufacturing process during the prioritization operation. Furthermore, the process collection can be sorted to determine the subsequent process in order to define a sequence of manufacturing processes. Determining the subsequent process using the process collection can reduce material waste and/or the complexity of the process change for the operator during the process change, especially if the greatest possible similarity between the manufacturing process and the subsequent process is achieved.

According to a further aspect of the invention, there is provided a computer program product comprising instructions which, when executed by a control system, cause the control system to execute a method according to the invention.

Thus, a computer program product according to the invention has the same advantages as those already described in detail with reference to a method according to the invention. In particular, the method may be a computer-implemented method. The computer program product may be implemented as a computer-readable instruction code. Further, the computer program product may be stored on a computer-readable storage medium such as a data disk, a removable drive, a volatile or non-volatile memory, or a built-in memory/processor. Furthermore, the computer program product can be made available or provided on a network, such as the Internet, from which it can be downloaded or executed online by a user as required. The computer program product can be realized through software as well as through one or more special electronic circuits, i.e. in hardware or in any hybrid form, i.e. through software components and hardware components.

According to a further aspect of the invention, a system for guiding a user is provided. The system comprises an extrusion device for implementing a manufacturing process for manufacturing a first film material. Further, the system comprises a control system for implementing a method according to the invention.

Thus, a system according to the invention has the same advantages as those already described in detail with reference to a method according to the invention and/or a computer program product according to the invention. The control system may preferably comprise a monitoring device, in particular comprising a processor and/or microprocessor, for executing the method. Furthermore, the monitoring device can be integrated into a control device of the extrusion device and/or into a control center. The control center may comprise a server and/or a cloud. It is also conceivable that the control system has several, in particular distributed, monitoring devices for executing the method. Furthermore, the control system can comprise a memory device and/or a database for providing the setpoint subsequent parameter set. The system may further comprise a display device for displaying information. For example, the display device may comprise a display and/or a touch screen. Advantageously, the display device can be integrated into the extrusion device and/or the control station. It is also conceivable that the display device is a mobile terminal device, such as a smartphone or a pager.

Further advantages, features and details of the invention are apparent from the following description, in which embodiments of the invention are described in detail with reference to the drawings. The features mentioned in the claims and in the description may be essential to the invention individually or in any combination. It shows schematically:

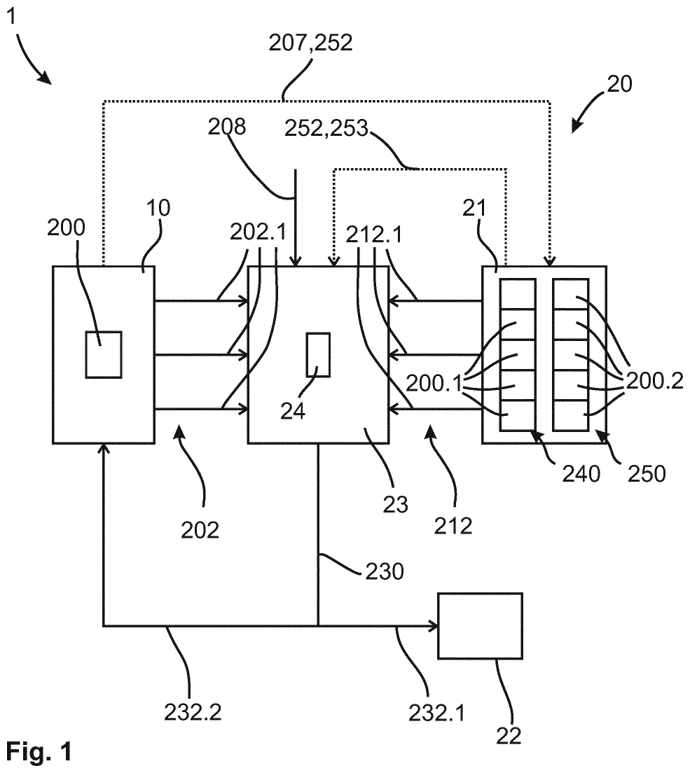

FIG. 1A system according to the invention when executing a method according to the invention,

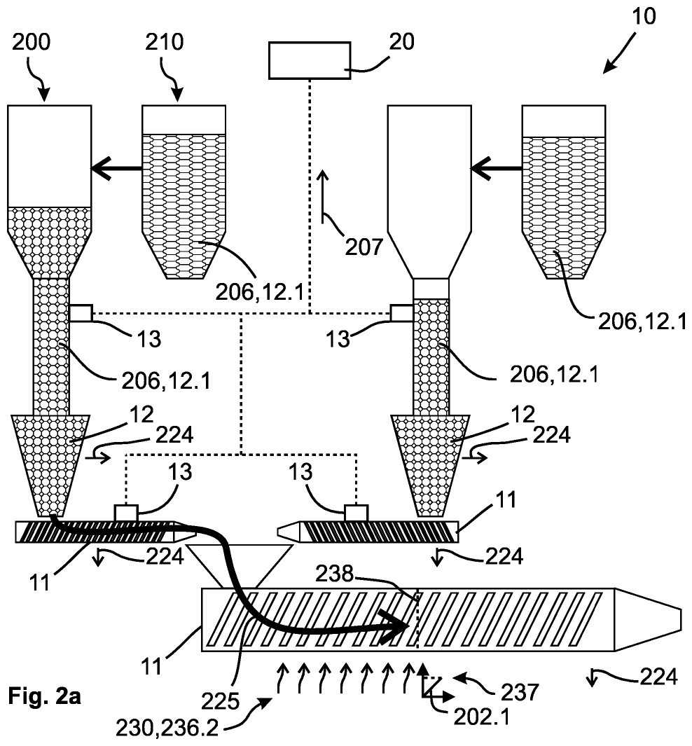

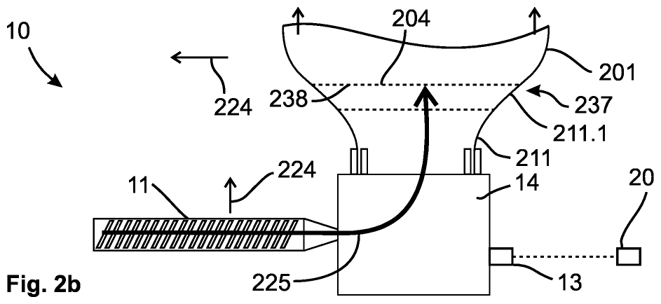

FIGS. 2a &2b Parts of an extrusion device of the system during a process change,

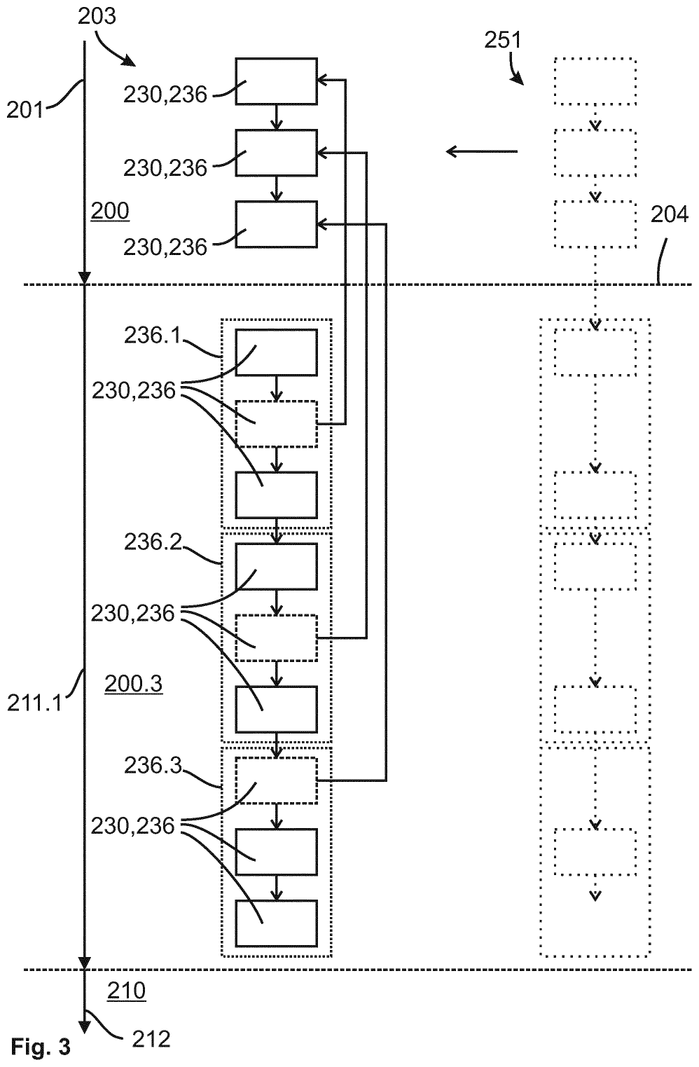

FIG. 3A process flow during the process change, and

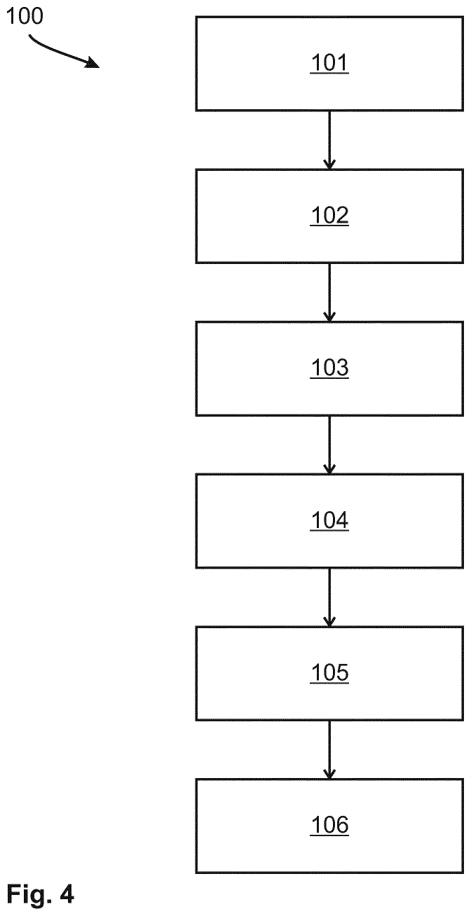

FIG. 4A schematic representation of the method stage of the method.

In the following description of some embodiments of the invention, the identical reference signs are used for the same technical features even in different embodiments.

FIG. 1 shows a system 1 according to the invention when executing a method 100 according to the invention for supporting an implementation of a process change from a manufacturing process 200 for manufacturing a first film material 201 to a subsequent process 210 for manufacturing a second film material 211 in a first embodiment. The implementation of the manufacturing process 200 for manufacturing a first film material 201 is carried out by the extrusion device 10. As shown in FIGS. 2a and 2b, the extrusion device 10 comprises a plurality of extruders 11 for extruding a plastic material. Furthermore, the extrusion device 10 has a plurality of feed devices 12 through which the extruders 11 are fed with different material ingredients 206. As shown in FIG. 2b, the extrusion device 10 in the present embodiment is a blown film machine with a film blowing head 14 for producing a film bubble, in the region of which the first film material 201 cools. However, it is also conceivable that the extrusion device of system 1 is a cast film machine, for example.

When an order for the production of the first film material 201 is completed, the process change from the manufacturing process 200 of the first film material 201 to the subsequent process 210 of the second film material 211 takes place without stopping the extrusion device 10. As shown in FIG. 2b, the process change can comprise a transition from the first film material 201 to the second film material 211. The transition may, for example, be generated stagelessly and/or by executing an intermediate process 200.3 to generate an intermediate material 211.1 in order to simplify and/or enable the process change. To support the process change from the manufacturing process 200 to the subsequent process 210, the system 1 comprises a control system 20, in particular comprising a monitoring device 23 in the form of a processor and/or microprocessor, for implementing the method 100. Preferably, a computer program product may be provided comprising instructions which, when executed by the control system 20, cause the control system 20 to execute the method 100. Method stages of the method 100 are shown schematically in FIG. 4.

In the method 100, a capturing 101 of process data 202 of the manufacturing process 200 and a capturing 102 of subsequent process data 212 of the subsequent process 210 take place. The process data 202 comprise in particular a process parameter set with one or more process parameters 202.1 of actual machine data and/or setpoint machine data of the extrusion device 10, in particular in the form of sensor data 207 and/or control and/or regulation data, for the manufacturing process 200. The subsequent process data 212 comprises, in particular, a setpoint subsequent parameter set with one or more subsequent process parameters 212.1 of setpoint machine data of the extrusion device 10, in particular in the form of control and/or regulation data for the subsequent process 210. Furthermore, the process data 202 and the subsequent process data 212 comprise, in particular, material data.

It may be provided that several orders are present in a process collection 240 for the manufacturing of different film materials 211, which are to be processed after the production of the first film material 201. In order to configuration the process change as efficiently as possible, a determination 103 of the subsequent process 210 can preferably first be carried out using the process collection 240, in that an analysis of the process collection 240 is carried out using the process data 202 and the subsequent process data 212. The analysis may, for example, determine which of the manufacturing processes 200.1 planned according to the process collection 240 requires the least adjustment and/or has the highest compliance with the current manufacturing process 200. The process collection 240 may be stored in a memory device 21 of the control system 20.

Depending on the process data 202 and the subsequent process data 212, a predetermination 104 of at least one material flow 225 within the extrusion device 10 for the process change is also carried out. The material flow 225 within the extrusion device 10 is shown in FIGS. 2a and 2b. The material flow 225 can, for example, be calculated using a calculation model 253 for a material distribution and/or a material movement in the extrusion device 10. Thus, the manufacturing process 200 and/or the process change can be mapped and/or predicted with a high degree of accuracy by the material flow 225.

Furthermore, at least one preparatory measure 230 is executed 105 to trigger at least one event 237 of the process change depending on the material flow 225. As shown in FIG. 1, the preparatory measure 230 comprises in particular an automatic control 232.2 of the extrusion device 10 and/or an output of a recommended action 232.1 for execution 105 by an operator. The extrusion device 10 can be controlled by control data of the control system 20 in order to realize the automatic control 232.2. The recommended action 232.1 may, for example, be visualized for an operator by a display device 22 of the control system 20. In particular, the event 237 may be caused by the execution 105 of the preparatory measure 230 at an event location 238 of the extrusion device 10. The execution 105 of the preparatory measure 230 is in particular coordinated in time with the material flow 225, so that the material flow 225 correlates in time with the event 237 at the event location 238. Furthermore, the preparatory measure 230 is preferably determined depending on a predefined target variable 208, in particular a target variable to be optimized, for the transfer of the extrusion device 10. The target variable 208 can be, for example, a material quantity, a changeover time of the process changeover, a quality criterion for the first film material 201 and/or the second film material 211 and/or a process reliability when implementing the process changeover.

For example, the material flow 225 may comprise a movement of a material in the extrusion device 10 to the event location 238 and the event 237 may comprise reaching a setpoint value of a process parameter 202.1. For example, FIG. 2a shows that a preparatory measure 230 is used to adjust 236.2 a temperature of an extruder 11 of the extrusion device 10 to the material flow 225 of a material ingredient 206 such that a predefined temperature value is reached when the material ingredient 206 arrives at the event location 238. As a result, the predefined temperature value can be reached at a late point in time in order to make the process change as sharp-edged as possible. Furthermore, as shown in the combined view of FIGS. 2a and 2b, this allows, for example, a material change to be carried out at a feed device 12 of the extrusion device 10 while a good production of the first film material 201 is still being output at the film blowing head 14 during the manufacturing process 200. For this, a balancing 224 of an amount of the first film material 201 and/or an amount of a material ingredient 206 introduced into the extrusion device 10 may be calculated. For example, a process completion 204 of the manufacturing process 200 can be calculated in advance depending on the material flow 225 for a point in time lying in the future during the balancing 224.

Further, as shown in FIG. 3, the preparatory measure 230 may include a plurality of change operations 236 for executing the process change. For example, the preparatory measure 230 may include a modification of a material supply 12.1, a modification 236.3 of the process data 202 for maintaining a bubble stability of a film bubble, in particular during the adjustment 236.2 of the temperature, and/or a start operation for the intermediate process 200.3 for generating an intermediate material. In this regard, the change operations 236 may be prioritized and/or sequentially output when implementing the preparatory measure 230 to guide the process change.

Furthermore, the preparatory measure 230 can comprise a rinsing operation 236.1 of at least a part of the extrusion device 10. The material flow 225 for a rinsing material of the rinsing operation 236.1 can be determined. Depending on the process data 202 and the material flow 225, a rinsing time of the rinsing operation 236.1 is also calculated in order to carry out the preparatory measure 230 depending on the rinsing time. As a result, the rinsing operation 236.1 can, for example, already be completed in the area of the feed devices 12, while completion of the rinsing operation 236.1 is not yet recognizable at the film blowing head 14, for example on the basis of residual particles and/or streak formation.

As further shown in FIG. 3, the preparatory measure 230 may be determined based on a recording of a reference change 251, which preferably represents a process change from the process data 202 to the subsequent process data 212. For example, for the recording of the reference change 251 by an experienced operator, multiple change actions can be performed and recorded so that subsequent operators can benefit from the experience of the experienced operator and be guided through the process change by the preparatory measure 230. The material flow 225 can be used to determine when the preparatory measure 230 should take place. It is also conceivable that the preparatory measure 230 is determined differently from a changeover action of the reference changeover 251 if the calculated material flow 225 deviates from the reference changeover 251.

Furthermore, it may be provided that a capturing 106 of sensor data 207, in particular of one or more sensors 13 of the extrusion device 10, is carried out to detect a modification in the manufacturing process 200 that occurs depending on the preparatory measure 230. The sensor data 207 is preferably monitored with respect to the target variable 208. This allows errors during the process change to be identified. Furthermore, the determination of the material flow 225 can be updated depending on the sensor data 207 in order to react dynamically to modified process conditions.

In addition or as an alternative to the reference change 251, it may be provided that the material flow 225 and/or the preparatory measure 230 is determined on the basis of a process history 250 of a previous manufacturing processes 200.2. The process history 250 can, for example, be part of a database and comprise implementation data 252, in particular with sensor data 207, of the preceding manufacturing processes 200.2. The current process change can be inferred from the implementation data 252 of the process history 250. In order to create a self-learning system 1, implementation data 252 of the preparatory measure 230 of the current process change can be stored, preferably depending on the sensor data 207, as part of the process history 250 for provision for further subsequent processes 210. In particular, the monitoring device 23 may comprise an artificial intelligence 24 to which the process data 202 and the subsequent process data 212 are fed as input data in order to receive the material flow 225 and/or the preparatory measure 230 as output data. Additionally or alternatively, the artificial intelligence 24 may be supplied with the implementation data 252 and/or the process history 250 with the sensor data 207, the process data 202 and/or the subsequent process data 212 as training data.

The foregoing explanation of the embodiments describes the present invention solely by way of examples. Of course, individual features of the embodiments may be freely combined with one another, provided that this is technically expedient, without departing from the scope of the present invention.

### LIST OF REFERENCE SYMBOLS

1 System
10 Extrusion device
10.1 Device section
11 Extruder
12 Feed device
12.1 Material supply
13 Sensor
14 Film blowing head
20 Control system
21 Memory device
22 Display device
23 Monitoring device
24 Artificial intelligence
100 Method
101 Capturing 202
102 Capturing 212
103 Determine 210
104 Predetermination of 225
105 Execution of 230
106 Capturing 207
200 Manufacturing process
200.1 Planned manufacturing process
200.2 Preceding manufacturing process
200.3 Intermediate process
201 First film material
201.1 Material sections
202 Process data
202.1 Process parameter set
204 Process completion
206 Material ingredient
207 Sensor data
208 Target variable
210 Subsequent process
211 Second film material
211 Different film materials
212 Subsequent process data
212.1 Subsequent process parameter set
224 Balancing
225 Material flow
230 Preparatory measure
232.1 Recommended action
232.2 Control
235 Material change
236 Changing actions
236.1 Rinsing operation
236.2 Adjustment of a temperature
236.3 Modification of 202 to maintain stability of the film bubble
237 Event
238 Event location
240 Process collection
250 Process history
251 Reference change
252 Implementation data
253 Calculation model

1. A method for supporting an implementation of a process change from a manufacturing process for manufacturing a first film material to a subsequent process for manufacturing a second film material in an extrusion device,
comprising:
capturing of process data of the manufacturing process,
capturing of subsequent process data of the subsequent process
predetermining at least one material flow within the extrusion device for the process change depending on the process data and the subsequent process data,
executing at least one preparatory measure for causing at least one event of the process change in dependence on the material flow.

2. The method according to claim 1,
wherein
the preparatory measure comprises at least an automatic control of the extrusion device or an output of a recommended action for execution by an operator.

3. The method according to claim 1,
wherein
the predetermination of the material flow is carried out using a calculation model at least for a material distribution or a material movement in the extrusion device.

4. The method according to claim 1,
wherein
the event can be caused or is caused by the execution of the preparatory measure at an event location of the extrusion device, and the execution of the preparatory measure is coordinated in time with the material flow, so that the material flow correlates in time with the event at the event location.

5. The method according to claim 1,
wherein
the material flow comprises a movement of a material in the extrusion device to the event location, the event comprising reaching a setpoint value of a process parameter at the event location.

6. The method according to claim 1,
wherein
the preparatory measure comprises at least one of the following change operations at least in part:
modifying of a material supply,
adjusting of a temperature of the extrusion device,
modifying of the process data for maintaining a bubble stability of a film bubble,
generating an intermediate material for a start operation for an intermediate process.

7. The method according to claim 1,
wherein
the preparatory measure comprises a plurality of change operations for executing the process change, the change operations at least being prioritized or output in succession when the preparatory measure is implemented.

8. The method according to claim 1,
wherein
the preparatory measure is determined on the basis of a recording of a reference change.

9. The method according to claim 1,
wherein
the preparatory measure comprises a rinsing operation of at least a part of the extrusion device.

10. The method according to claim 1,
wherein
a rinsing time of the rinsing operation is calculated depending on the process data and of the material flow, the preparatory measure being carried out depending on the rinsing time.

11. The method according to claim 1,
wherein
a process completion of the manufacturing process is precalculated depending on the material flow.

12. The method according to claim 1,
wherein
the preparatory measure is determined depending on a predefined target variable at least for the transfer of the extrusion device, a changeover time of the process changeover, a quality criterion at least for the first film material or the second film material or a process reliability when implementing the process changeover.

13. The method according to claim 1,
wherein
a balancing at least of a quantity of the first film material or a quantity of a material ingredient introduced into the extrusion device takes place.

14. The method according to claim 1,
wherein
the balancing is carried out depending on the predetermination of the material flow for a point in time lying in the future when the balancing is carried out.

15. The method according to claim 1,
wherein
the method comprises:
capturing sensor data for detecting a modification in the manufacturing process that occurs depending on the preparatory measure.

16. The method according to claim 1,
wherein
at least the material flow or the preparatory measure is determined on the basis of a process history of preceding manufacturing processes.

17. The method according to claim 1,
at least wherein
an artificial intelligence is provided, to which the process data and the subsequent process data are fed as input data in order to receive at least the material flow or the preparatory measure as output data, or wherein at least the implementation data or the process history are fed to the artificial intelligence at least with the sensor data, the process data or the subsequent process data as training data.

18. The method according to claim 1,
wherein
the method comprises:
determining the subsequent process on the basis of a process collection for manufacturing different film materials by analyzing the process collection on the basis of the process data and the subsequent process data.

19. A computer program product comprising instructions which, when executed by a control system, cause the control system to execute a method according to claim 1.

20. A System comprising
an extrusion device for implementing a manufacturing process for manufacturing a first film material, and
a control system for implementing a method according to claim 1.
